(19) United States
(12) Patent Application Publication
(10) Pub. No.: US 2024/0157928 A1
(43) Pub. Date: May 16, 2024

(54) Load-Reducing Motorized Trailer

(71) Applicant: The Noco Company, Glenwillow, OH (US)

(72) Inventors: James Richard Stanfield, Glendale, AZ (US); Bruce Moore, Glendale, AZ (US)

(21) Appl. No.: 18/506,299

(22) Filed: Nov. 10, 2023

Related U.S. Application Data
(60) Provisional application No. 63/424,980, filed on Nov. 14, 2022.

(51) Int. Cl. B60W 10/04; B60W 10/18; B60W 30/18

(52) U.S. Cl. CPC B60W 10/04; B60W 10/18; B60W 30/18127; B60W 2300/14; B60W 2530/207; B60W 2720/10; B60Y 2300/28

(57) ABSTRACT

Systems and methods are provided for reducing a variation of force between a trailer and a towing vehicle and for maintaining the performance of the towing vehicle when the trailer is attached to it. A trailer may be configured to attach to a towing vehicle. The trailer may comprise a load sensor configured to detect a towing force between the trailer and the towing vehicle and to generate a load signal based on the towing force. The trailer may also comprise a control system coupled to the load sensor that includes a power source and a motor coupled to the power source. The motor may be configured to apply a propulsive force to the trailer. The control system may be configured to receive the load signal and to decrease the propulsive force based on the load signal. The increasing or decreasing of the propulsive force may reduce the towing force.

### CROSS-REFERENCE TO RELATED APPLICATION

This application claims priority to U.S. Provisional Application No. 63/424,980, filed on Nov. 14, 2022, the entirety of which is incorporated herein by reference.

### FIELD

The present disclosure relates to electric vehicles and trailers of towing vehicles.

### BACKGROUND

Conventional trailers attach to a towing vehicle and can be used to transport various items. Conventional trailers typically include a trailer coupler used to attach the trailer to a trailer ball of the towing vehicle. A platform or storage area is provided to contain the items being transported. Wheels are provided for traveling along a road or path.

Several drawbacks are associated with conventional trailers. For example, significant variations in force can be realized at the point of contact between the trailer and the towing vehicle. These variations in force may be due to acceleration and deceleration of the towing vehicle and can cause strain on the towing vehicle and the trailer. Sudden acceleration or deceleration of the towing vehicle can also cause instability of the trailer, which must absorb the resultant forces. Furthermore, the increased load on the towing vehicle due to the trailer can cause a decrease in the performance of the towing vehicle. This is because the power source (e.g., engine) of the towing vehicle must transport the load of the trailer and its contents in addition to the load of the towing vehicle. Therefore, there is a need in the art for reducing the variation of force between the trailer and the towing vehicle and for maintaining the performance of the towing vehicle when a trailer is attached to it.

### SUMMARY

Systems and methods are provided for reducing a variation of force between a trailer and a towing vehicle and for maintaining the performance of the towing vehicle when the trailer is attached to it. A trailer may be configured to attach to a towing vehicle. The trailer may comprise a load sensor configured to detect a towing force between the trailer and the towing vehicle and to generate a load signal based on the towing force. The trailer may also comprise a control system coupled to the load sensor that includes a power source and a motor coupled to the power source. The motor may be configured to apply a propulsive force to the trailer. The control system may be configured to receive the load signal and to decrease the propulsive force based on the load signal. The increasing or decreasing of the propulsive force may reduce the towing force.

The control system may further comprise a braking system configured to apply a braking force to one or more wheels of the trailer. When the load signal indicates that the trailer is exerting a net force on the towing vehicle, the braking system may apply regenerative braking to slow the trailer and charge the power source. The control system may further comprise a control module coupled to the motor that is configured to receive the load signal and to generate a propulsion signal based on the load signal. The motor may be configured to receive the propulsion signal and to increase or decrease the propulsive force based on the propulsion signal. The trailer may be further configured to detect that the trailer is detached from the towing vehicle. The braking system may be further configured to apply the braking force based on the determination that the trailer is detached from the towing vehicle.

The trailer may further comprise two or more wheels. The trailer may be configured to charge the power source based on rotational energy of the two or more wheels. The load sensor may be a strain gauge or load cell. The power source may be a battery. The battery may be a lithium-ion battery. The trailer may further comprise an independent control interface coupled to the motor. The motor may be configured to apply the propulsive force based on a user input at the independent control interface. The independent control interface may be detachable from the trailer. The trailer may further comprise a brake light. The trailer may be configured to activate the brake light based on the load signal.

A method is provided for reducing a load on a towing vehicle. The method may comprise determining a towing force applied by a trailer to the towing vehicle. The towing force may include a pushing force when the trailer is pushing the towing vehicle and a loading force when the trailer is loading the motor vehicle. Based on a determination that the trailer is pushing the towing vehicle, a forward force applied to the trailer may be reduced. Based on a determination that the trailer is loading the towing vehicle, the forward force applied to the tailer may be increased.

A magnitude of the reduction of the forward force may be based on a magnitude of the pushing force and a magnitude of the increase of the forward force may be based on a magnitude of the loading force. The method may further comprise charging a battery of the trailer with a motor of the trailer based on the determination that the trailer is pushing the towing vehicle. The method may further comprise charging a power source of the trailer based on rotational energy of one or more tires of the trailer. The step of determining the towing force may comprise measuring a load sensor. The method may further comprise filtering a load signal from the load sensor.

A method is provided for reducing a load on a towing vehicle. The method may comprise determining that the towing vehicle is traveling in a reverse direction. The method may further comprise determining a towing force applied by a trailer to the towing vehicle. The towing force may include a pushing force when the trailer is pushing the towing vehicle and a loading force when the trailer is loading the motor vehicle. Based on a determination that the trailer is pushing the towing vehicle, a rearward force applied to the trailer may be increased. Based on a determination that the trailer is loading the towing vehicle, the rearward force applied to the trailer may be decreased.

### BRIEF DESCRIPTION OF THE DRAWINGS

The following detailed description will be better understood when read in conjunction with the appended drawings. For the purpose of illustration, there is shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIG. 1 depicts a load-reducing motorized trailer attached to a towing vehicle, in accordance with some embodiments.

FIG. 2 depicts a control flow block diagram, in accordance with some embodiments.

FIG. 3 depicts a connectivity diagram of the load-reducing electric trailer, in accordance with some embodiments.

FIG. 4 depicts an electric trailer used as a home battery backup system, in accordance with some embodiments.

FIG. 5A depicts a single-axle motorized trailer with an independent control interface, in accordance with some embodiments.

FIG. 5B depicts a dual-axle motorized trailer with an independent control interface, in accordance with some embodiments.

FIG. 6 depicts a method of reducing a load on a towing vehicle, in accordance with some embodiments.

FIG. 7 depicts another method of reducing a load on a towing vehicle, in accordance with some embodiments.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention, and be protected by the accompanying claims.

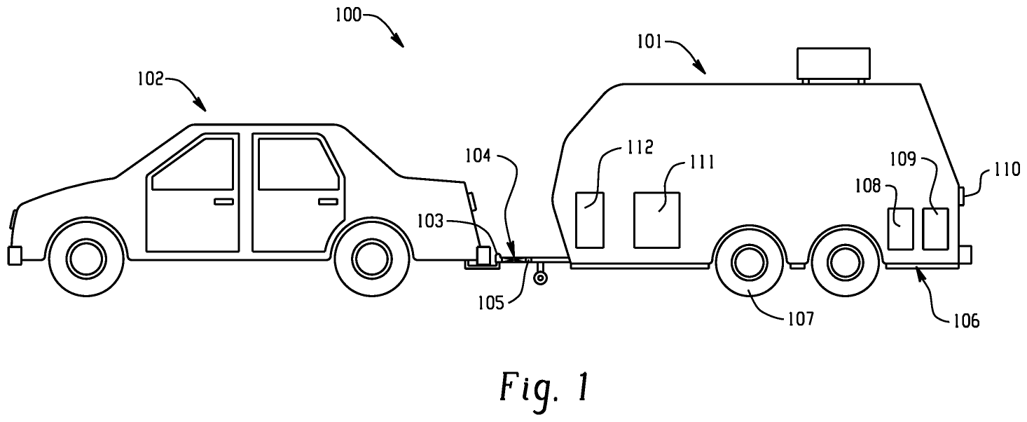

FIG. 1 depicts a load-reducing motorized trailer attached to a towing vehicle, in accordance with some embodiments. In the example embodiment shown in FIG. 1, the towing vehicle 102 includes a trailer hitch and a ball mount to which a trailer ball 103 is mounted. A trailer coupler 104 on the load-reducing motorized trailer 101 is used to attach and secure the trailer 101 to the towing vehicle 102. The trailer coupler 104 may include a load sensor (e.g., strain gauge or load cell) 105 that can measure a towing force exerted on the towing vehicle 102 by the trailer 101. This towing force may be positive when the trailer 101 is pushing the towing vehicle 102. For example, the force may be positive when the towing vehicle 102 is slowing down. In contrast, the towing force may be negative (e.g., the towing vehicle 102 is exerting a net force on the trailer) when the towing vehicle 102 is accelerating. This may be described as the trailer 101 “loading” or “pulling” the towing vehicle 102.

The load sensor 105 may produce a load signal based on the magnitude and direction of the towing force. For example, if the trailer 101 is exerting a relatively high force on the towing vehicle 102, the load sensor 105 can generate a load signal with a relatively high magnitude. In addition, a positive value of the load signal may indicate that the trailer 101 is pushing the towing vehicle 102. Similarly, a negative value of the load signal may indicate that the towing force is negative, and the magnitude of this load signal may reflect the magnitude of this negative towing force. In other example embodiments, the load signal reflects only the magnitude of the towing force, and a separate signal indicates whether the trailer 101 is loading or pushing the towing vehicle 102.

The load-reducing motorized trailer 101 may also include a power source (e.g., battery or battery pack) 106. In some example embodiments, the power source 106 is located at the base of the trailer 101 in a “skateboard” design. This lower position of the power source 106 can provide a low center of gravity, reducing the possibility of the trailer 101 tipping over when performing turns or traversing through hills or valleys. In addition, a location at the base can allow the power source 106 to be replaced with a separate power source if the installed power source 106 is depleted or discharged. The power source 106 can be coupled to a motor 108, which can be used to apply a rotational force to wheels 107 of the motorized trailer 101. The magnitude of the force applied to the wheels 107 of the trailer 101 may depend upon the load signal, as described further below.

The load-reducing motorized trailer 101 may also include a braking system 109. The braking system 109 can be configured to apply a braking force to the wheels 107 of the trailer 101 and may be coupled to the power source 106 in order to obtain the power necessary to apply the braking force. The braking system 109 can employ regenerative braking technology to both slow the trailer 101 and charge the power source 106. For example, when the braking force is applied, the energy from the spinning wheels 107 can be used to reverse the direction of electricity so that it flows from the motor 108 to the power source 106. This can result in a longer lifespan of the power source 106 and a more efficient use of energy. The braking system 109 may also include one or more brake pads (not shown) for applying the braking force to the trailer tires 107.

The braking system 109 can include one or more trailer brake lights 110 that illuminate when the braking force is applied to the wheels 107. The trailer brake lights 110 may be coupled to a braking system of the towing vehicle 102. Thus, when the towing vehicle 102 is applying its brakes, the trailer brake lights 110 may illuminate. The trailer brake lights 110 may also be coupled directly to the load sensor 105, so that the brake lights 110 are illuminated based on the load signal. For example, if the load signal indicates that the trailer 101 is pushing the towing vehicle 102, the brake lights 110 may illuminate. Because the load sensor 105 can indicate that the trailer 101 is pushing the towing vehicle 102 regardless of the connectivity of the towing vehicle's braking system to the trailer braking lights 110, the brake lights' 110 illumination based on the load signal may provide a form of redundancy to the operation of the trailer brake lights 110.

The load-reducing motorized trailer 101 may also include a control module 111. The control module 111 may be coupled to the load sensor 105, the power source 106, and the braking system 109. The control module 111 can be configured to minimize the towing force. For example, the control module 111 may receive the load signal from the load sensor 105. If the load signal indicates a positive towing force (e.g., the trailer 101 is pushing the towing vehicle 102), the control module 111 may generate a braking signal. The magnitude of this braking signal may depend upon the magnitude of the load signal. For example, if the load signal has a large magnitude due to the trailer 101 exerting a large magnitude of force on the towing vehicle 102, the control module 111 may generate a braking signal with a large magnitude. If the control module 111 receives a load signal indicating a negative towing force (e.g., the trailer 101 is loading the towing vehicle 102), the control module 111 may generate a propulsion signal. The magnitude of the propulsion signal may depend on the magnitude of the load signal. In some example embodiments, the trailer 101 may reduce the magnitude of the propulsion signal rather than or in addition to producing the braking signal when the load signal indicates that the trailer 101 is pushing the towing vehicle 102.

The braking system 109 may be configured to receive the braking signal and to apply the braking force to the wheels 107 of the motorized trailer 101 based on the braking signal. As described above, the braking system 109 may employ regenerative braking to both slow the trailer 101 and charge its own power source (e.g., battery) 106. The magnitude of the braking force applied to the wheels 107 may depend on the magnitude of the braking signal. For example, the braking system may apply a relatively small braking force if the braking signal contains a relatively small magnitude. When the braking system 109 applies the braking force to the wheels 107, the force exerted on the towing vehicle 102 by the trailer may be reduced. Consequentially, the load signal generated by the load sensor 105 may decrease in magnitude. This decreased load signal can then be received by the control module 111, resulting in a braking signal with a decreased magnitude and a lower braking force applied by the braking system 109. In this manner, the braking system 109 can work in conjunction with the control module 111 to minimize the force exerted on the towing vehicle 102 by the trailer 101. Thus, the braking system 109 may operate in real-time and continuously or at regular intervals (e.g., 60 Hz) receive updated braking signals.

The motor 108 of the load-reducing motorized trailer 101 may be configured to receive the propulsion signal and to propel the wheels 107 of the trailer 101 based on the propulsion signal. The magnitude of the propulsion applied to the wheels 107 may depend on the magnitude of the propulsion signal. For example, the motor 108 may apply a relatively large propulsive force to the wheels 107 if the propulsion signal contains a relatively large magnitude. When the motor 108 applies the propulsive force to the wheels 107, the force exerted on the trailer 101 by the towing vehicle 102 may be reduced. Consequentially, the load signal generated by the load sensor 105 may decrease in magnitude. This decreased load signal can then be received by the control module 111, resulting in a propulsion signal with a decreased magnitude and a lower propulsive force applied by the motor 108. A load signal within a specified range may indicate that the trailer 101 is neither pushing nor loading the towing vehicle 102. For example, the trailer and towing vehicle combination 100 may be considered “load neutral” when the load signal is within a specified range. This specified range may be adjustable by an operator of the trailer 101 or a driver of the towing vehicle 102. The motor 108 can thus work in conjunction with the control module 111 to minimize the force exerted on the trailer 101 by the towing vehicle 102. The motor 108 may operate in real-time and continuously or regularly receive updated propulsion signals.

The motor 108 may also receive the braking signal. The motor 108 may reduce the propulsive force based on the braking signal. In some example embodiments, the motor 108 and the braking system 109 work in conjunction to reduce the force exerted on the towing vehicle 102 by the trailer 101 based on the braking signal. For example, if the load signal indicates that the trailer 101 is exerting a force on the towing vehicle 102 above a predetermined threshold, the motor 108 may reduce the propulsive force. If the load signal indicates that the trailer 101 is exerting a force on the towing vehicle 102 below the predetermined threshold, the braking system 109 may apply the braking force to more effectively reduce the force on the towing vehicle 102 from the motorized trailer 101.

As detailed above, the braking system 109, motor 108, and control module 111 can work in combination with one another to minimize the towing force between the trailer 101 and the towing vehicle 102. When the trailer 101 is exerting a net force on the towing vehicle 102, the braking system 109 or motor 108 may apply an appropriate force to the trailer wheels 107 to minimize or reduce the magnitude of the towing force. When the towing vehicle 102 is exerting a net force on the trailer 101, the motor 108 may generate an appropriate amount of force to minimize or reduce the magnitude of the towing force. This reduced towing force can reduce strain on the towing vehicle 102 and the trailer 101. Furthermore, the reduced towing force can increase stability of the trailer 101 when the towing vehicle 102 engages in sudden acceleration or deceleration. In addition, the independent power source of the towing vehicle 102 can increase the total travel distance of the towing vehicle and trailer combination 100 by eliminating the need for a single towing vehicle engine to transport the entire load of the towing vehicle and trailer 100.

In some example embodiments, the load-reducing motorized trailer 101 does not include a control module 111. Instead, the load sensor 105 is coupled to the motor 108 and braking system 109, which receive the load signal directly. For example, the load sensor 105 may generate an analog voltage output signal, which can be received as an input to the motor 108 and used to control the torque generated by the motor 108. Similarly, the analog output signal generated by the load sensor 105 may be received by the braking system 109 and used to control the braking force applied by the braking system 109. Electrical components (e.g., transformers) may be employed to provide necessary adjustments to the load signal for reception at the motor 108 and the braking system 109. For example, a step-up transformer may be implemented to increase the magnitude of the load signal to render it an appropriate input for the motor 108 depending on the motor's 108 characteristics. The braking system 109 and motor 108 may operate in real-time in example embodiments in which a control module 111 is not employed. In example embodiments in which a control module 111 is not included, the output of the load sensor 105 received by the motor 108 may be referred to as a propulsion signal, and the output of the load sensor 105 received by the braking system 109 may be referred to as a braking signal.

The motorized trailer 101 may also be capable of operating in a passive charging mode. In the passive charging mode, the motor 108 or the braking system 109 may be deactivated. The motorized trailer 101 can travel based on its connection to the towing vehicle 102, rather than based on propulsion from its power source 106. The rotational kinetic energy of the trailer wheels 107 can be utilized to generate electric power that can be used to charge the trailer's power source 106. For example the trailer wheels 107 may generate alternating current (AC) power based on their rotation. This AC power can be received at a rectifier (not shown) to generate direct current (DC) power. This DC power can in turn be used to charge the power source 106 of the motorized trailer 101. This feature of the motorized trailer 101 may be useful when the power source 106 is partially or fully discharged or depleted.

Similar methods may be employed to minimize the towing force when the towing vehicle 102 and trailer 101 are traveling in reverse. However, when the towing vehicle 102 is traveling in reverse, the direction of the towing force may have differing implications for the resulting operation of the braking system 109 and motor 108. For example, when the towing vehicle 102 is traveling in a forward direction, an indication that the trailer 101 is exerting a net force on (e.g., pushing) the towing vehicle 102, the braking system 109 may be configured to apply a braking force to the trailer wheels 107 in order to reduce the towing force. In contrast, when the towing vehicle 102 is traveling in reverse, an indication that the trailer 101 is exerting a net force on the towing vehicle 102 signifies that the trailer 101 should accelerate in the reverse direction. Thus, the motor 108 may be configured to accelerate in either a forward or a reverse direction in order to minimize the towing force whether the towing vehicle 102 is traveling in a forward direction or a reverse direction.

Similarly, the operation of the braking system 109 can depend on the direction in which the towing vehicle 102 is traveling. For example, as described above, when the towing vehicle 102 is traveling forward and is exerting a net force on the trailer 101 (e.g., the trailer 101 is loading the towing vehicle 102), the motor 108 may be engaged to supply additional torque to the wheels 107 in a forward direction and thus reduce the towing force. However, when the towing vehicle 102 is traveling in reverse, an indication that the trailer 101 is loading the towing vehicle 102 may signify that a braking force should be applied to the wheels 107 of the trailer 101. Thus, the braking system 109 may be configured to apply a braking force that is not only dependent upon the towing force, but also on the direction of the towing vehicle 102.

The load-reducing motorized trailer 101 may be equipped with a direction detector 112 for detecting the direction in which the trailer 101 is traveling, or the trailer 101 may be coupled to a component (e.g., transmission) of the towing vehicle 102 so that it can determine the transmission gear (e.g., “forward” or “reverse”) of the towing vehicle 102. This direction detector 112 or component of the towing vehicle 102 may be coupled to the control module 111 or directly to the motor 108 and braking system 109 and used in the implemented logic to reduce the towing force.

The load-reducing motorized trailer 101 may include a feature allowing it to safely stop if it inadvertently becomes disconnected from the towing vehicle 102. The trailer may utilize electric motor regeneration for controlling the stop. For example, the trailer 101 may be configured to detect when the trailer 101 becomes disconnected from the towing vehicle 102. This may be accomplished by a detection of the load signal being above or below a certain threshold, or a separate continuity signal may be used which indicates the connectivity of the trailer 101 to the towing vehicle 102. When the trailer 101 detects that it has become inadvertently disconnected, it may utilize the motor 108 or the braking system 109 to arrive at a controlled stop. Antilock braking may also be employed to control the stop with reduced slipping or skidding.

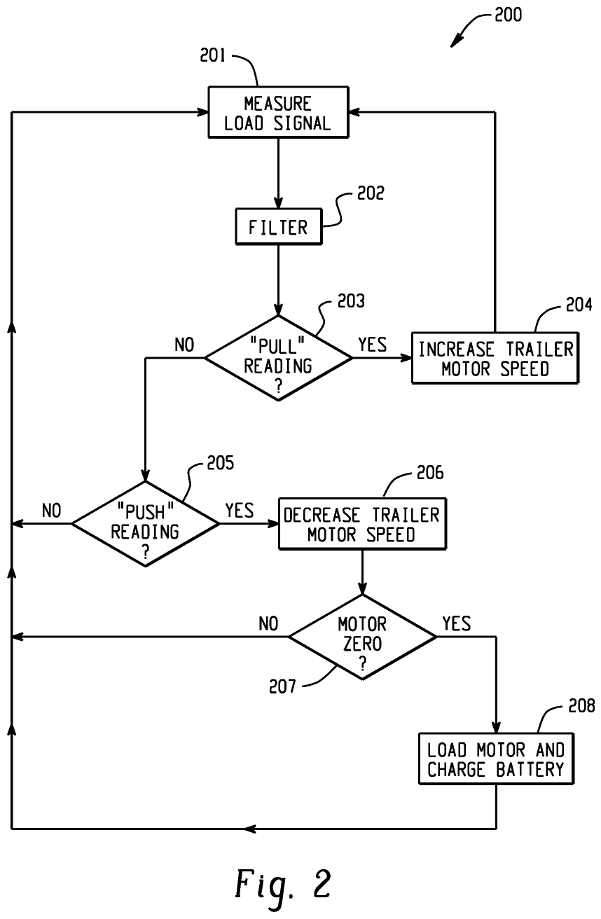

FIG. 2 depicts a control flow block diagram 200, in accordance with some embodiments. FIG. 2 may best be understood when read in conjunction with FIG. 1 and its accompanying description. In the example embodiment shown in FIG. 2, the load signal is measured at block 201. This load signal may be generated by the load sensor 105, as described above. The load signal can then be filtered to eliminate electrical noise, as shown by block 202. Thereafter, the filtered signal can be utilized to determine whether there is a “pull” reading (e.g., whether the trailer 101 is loading the towing vehicle 102), as shown by block 203. If there is a “pull” reading based on the load signal, the motor 108 may increase its speed in a forward direction. This is depicted by block 204. If there is not a “pull” reading, the load signal can be utilized to determine whether there is a “push” reading (e.g., whether the trailer 101 is exerting a net force on the towing vehicle 102), as depicted by block 205. If there is no “push” reading and also no “pull” reading, the load signal is sufficiently minimized and the operations of the braking system 109 and the motor 108 may remain unchanged. As indicated above, a load signal within a specified range may indicate that the trailer 101 is neither pushing nor pulling the towing vehicle 102.

If there is a “push” reading at block 205, the motor speed may be reduced. This is illustrated by block 206. A similar result may be achieved by applying a braking force to the trailer wheels 107 at block 206. The speed of the motor 108 can then be detected to determine whether the motor 108 has zero speed, as shown at block 207. If the motor 108 has zero speed and therefore cannot be reduced, the power source (e.g., battery) 106 can then be used to “load” the motor 108 and the power source 106 can be charged with the power generated by the motor 108. This is depicted by block 208. This can result in efficient energy usage because the energy used from the motor 108 to charge the power source may otherwise have been wasted. The example control flow block diagram 200 illustrates an embodiment in which the towing vehicle 102 is operating in a forward direction. The diagram 200 may be altered for embodiments in which the towing vehicle 102 is traveling in a reverse direction while remaining within the spirit and scope of the present disclosure.

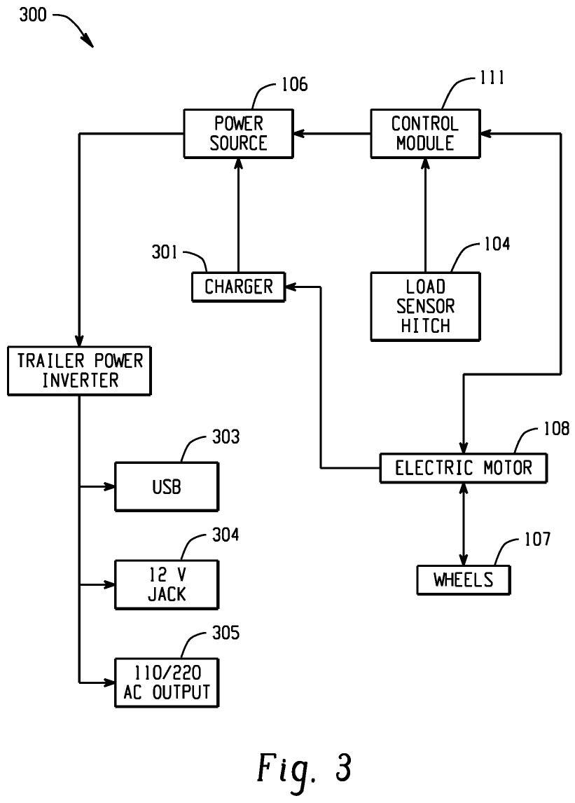

FIG. 3 depicts a connectivity diagram of the load-reducing electric trailer, in accordance with some embodiments. In the example embodiment depicted in FIG. 3, the load-reducing trailer 101 includes a power source (e.g., battery) 106. The battery 301 may be coupled to the control module 111. The trailer coupler 104 may be coupled to the control module 111 which can be utilized for controlling the motor 108. As discussed above, the trailer coupler 104 may include a load sensor (e.g., strain gauge or load cell) 105 for measuring a force between the motorized trailer 101 and the towing vehicle 102. As depicted by the arrows directed to both the control module 111 and the motor 108, one or more signals from the control module 111 can serve as inputs to the motor 108, and the motor 108 can provide feedback to the control module 111. As discussed above, this feedback may be indirect as the motor 108 can affect the towing force which in turn alters the tow signal which is received by the control module 111. In some example embodiments, the motor 108 produces a feedback signal which is received directly by the control module 111 for control or monitoring purposes.

The motor 108 can be coupled to a charger 301 which can be used to charge the power source 106. As discussed above with reference to FIG. 2, the charger 301 may be utilized when the trailer 101 is pushing the towing vehicle 102 and the motor 108 is not deriving any power from the power source 106. Thus, the power source 106 may be charged when the trailer 101 is being operated, extending the life of the power source 106. The motor 108 may also be connected to the wheels 107 of the trailer 101 and can control the torque and speed of the wheels 107 depending on signals received from the control module 111 or the load sensor 101, as discussed above. The power source 106 may be coupled to a trailer power inverter 302. The trailer power inverter 302 can be used to generate AC power for use at an output port such as a 110 VAC output port 305. The trailer 101 may also include additional or alternate ports such as a USB or USB-C port 303 or a 12 VDC power output port 304. Additional electrical components such as a rectifier or transformer may be implemented to provide the appropriate transformation of power from the power source 106 to the respective output port (303, 304, 305).

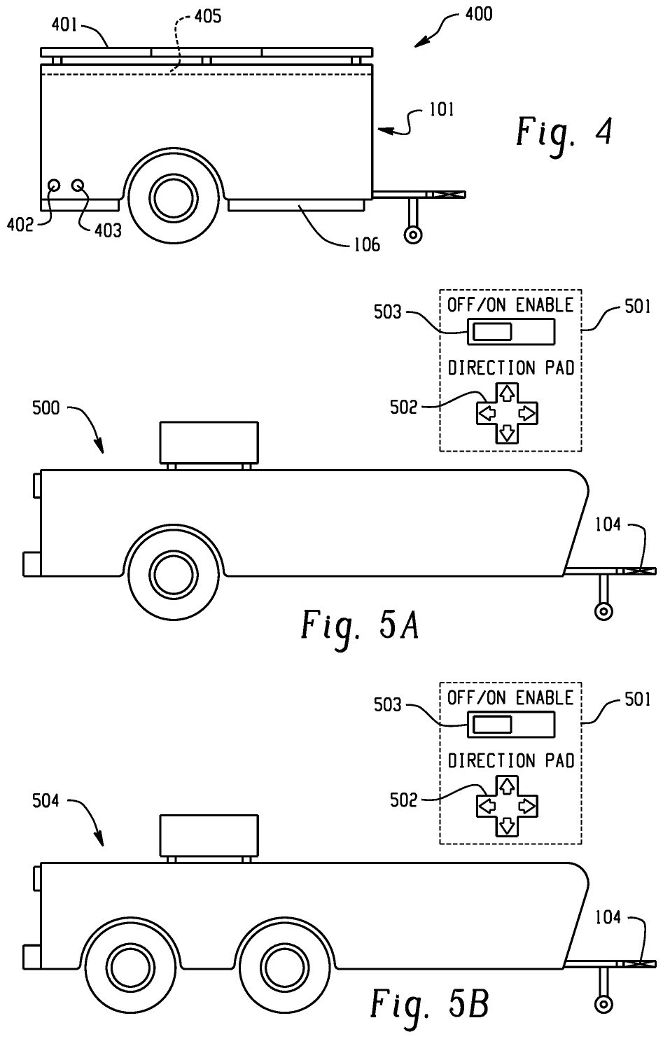

FIG. 4 depicts a motorized trailer used as a home battery backup system, in accordance with some embodiments. The motorized trailer used as a home battery backup system 400 may be utilized when a home power source (e.g., battery) fails. The motorized trailer 101 may thus effectively replace a power source of a home that derives its power from a renewable energy source (e.g., a solar panel), or it may serve as a generator. The electric trailer 101 may thus be capable of connecting to a solar panel or other renewable energy device. Additionally or alternatively, the trailer 101 may include a solar panel 401 on its external surface that is capable of receiving sunlight and converting the energy from the sunlight into electrical energy that can be consumed by a home or another trailer. Energy that is not consumed immediately by the home or other external source may be stored in the trailer power source 106. The motorized trailer 101 in the example embodiment depicted in FIG. 4 includes a power source 106 in the form of a lithium battery pack. The driving function of the motorized trailer 101 described above may be disabled when the motorized trailer 101 is being used to power a home or other external source.

The motorized trailer 101 may also include an elevating ceiling 405 that can raise and allow the trailer to transform into a camper that can be occupied by one or more people. The ceiling 405 may be capable of returning to a lower elevation when the trailer 101 is traveling or being towed. The trailer 101 may also include a charging port 402 for charging the power source 106 of the trailer 101. This feature may be useful for long camping or road trips. The motorized trailer 101 may also include a power output port 403 coupled to the power source 106 of the trailer 101 and used to generate electrical power from the power source 106 to be consumed by the home or external device. For example, a power cord may be used to connect a home with the trailer 101 at the power output port 403. The power output port 403 may derive its power from both the solar panel 401 and the power source 106. In other example embodiments, the power output port 403 derives its power from either the power source 106 or the solar panel 401. The motorized trailer 101 may also include an inverter or a transformer (not shown) for transferring power from the power source 106 or the solar panel 401 to the power output port 403 in the proper form.

FIG. 5A depicts a single-axle motorized trailer with an independent control interface, in accordance with some embodiments. In the example embodiment included in FIG. 5A, the independent control interface 501 allows an operator of the motorized trailer 500 to control the movement of the trailer 500 when it is disconnected from the towing vehicle 102. The independent control interface 501 can be located on or inside the trailer 500. The independent control interface 501 may include one or more buttons 502 used to control the direction (e.g., forward, backward, left, right) of the trailer. The independent control interface 501 may also include one or more buttons (e.g., a switch) 503 used for enabling and disabling the independent control interface 501. The independent control interface 501 may also include the ability to raise or lower the trailer coupler 104. This ability can be utilized to attach the trailer 500 to the towing vehicle 102 without manually moving the trailer 500 or the towing vehicle 102. In some example embodiments, the independent control interface 501 may be located externally from the trailer 500. For example, the independent control interface 501 may be a remote control or a downloadable smart phone application that can wireless connect (e.g., via Bluetooth) to and control the movement of the trailer 500. FIG. 5B depicts a dual-axle motorized trailer with an independent control interface, in accordance with some embodiments. The operability of the dual-axle motorized trailer 504 may be similar or the same as the operability of the single-axle motorized trailer 500 with an independent control interface 501.

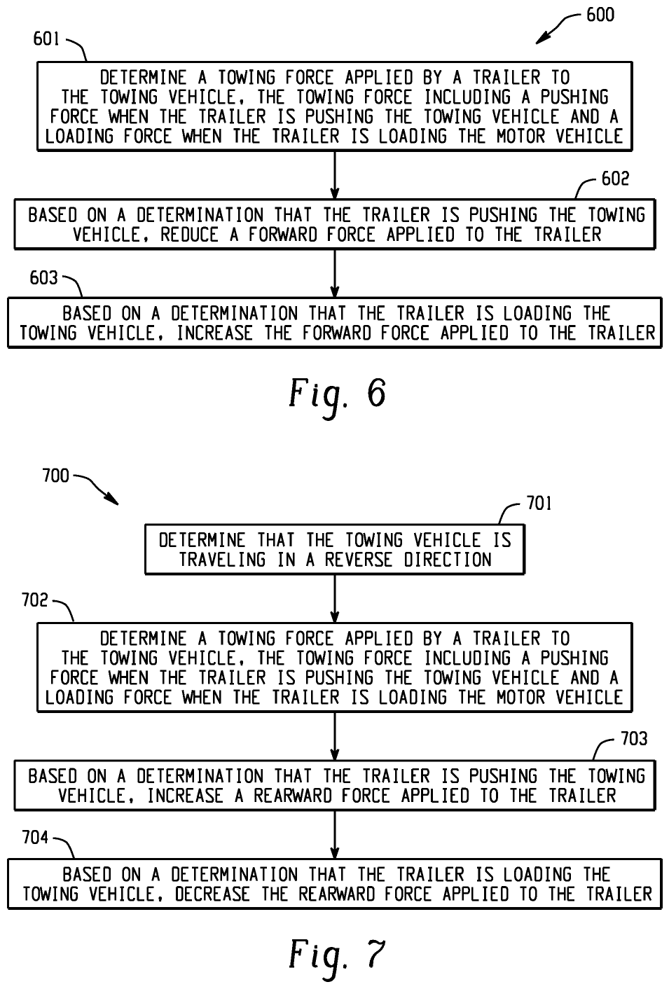

FIG. 6 depicts a method of reducing a load on a towing vehicle 600, in accordance with some embodiments. In some example embodiments, the method 600 includes a first step 601 of determining a towing force applied by a trailer to the towing vehicle, the towing force including a pushing force when the trailer is pushing the towing vehicle and a loading force when the trailer is loading the motor vehicle. The method 600 may include a second step 602 of reducing a forward force applied to the trailer based on a determination that the trailer is pushing the towing vehicle. The method 600 may include a third step 603 of increasing the forward force applied to the trailer based on the determination that the trailer is loading the towing vehicle. The steps depicted in FIG. 6 may be performed in an order that differs from the order depicted in FIG. 6. Furthermore, additional steps may be performed in addition to the steps depicted in FIG. 6 while remaining within the spirit and scope of the present disclosure.

FIG. 7 depicts another method of reducing a load on a towing vehicle 700, in accordance with some embodiments. In some example embodiments, the method 700 includes a first step 701 of determining that the towing vehicle is traveling in a reverse direction. The method 700 may include a second step 702 of determining a towing force applied by a trailer to the towing vehicle, the towing force including a pushing force when the trailer is pushing the towing vehicle and a loading force when the trailer is loading the motor vehicle. The method 700 may include a third step 703 of increasing a rearward force applied to the trailer based on a determination that the trailer is pushing the towing vehicle. The method 700 may include a fourth step 704 of decreasing the rearward force applied to the trailer based on the determination that the trailer is loading the towing vehicle. The steps depicted in FIG. 7 may be performed in an order that differs from the order depicted in FIG. 7. Furthermore, additional steps may be performed in addition to the steps depicted in FIG. 7 while remaining within the spirit and scope of the present disclosure.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

What is claimed is:

1. A trailer configured to attach to a towing vehicle, the trailer comprising:
a load sensor configured to detect a towing force between the trailer and the towing vehicle and to generate a load signal based on the towing force;
a control system coupled to the load sensor, the control system including:
a power source; and
a motor coupled to the power source, the motor configured to apply a propulsive force to the trailer;
the control system configured to receive the load signal and to increase or decrease the propulsive force based on the load signal, the increasing or decreasing of the propulsive force reducing the towing force.

2. The trailer of claim 1, the control system further comprising a braking system configured to apply a braking force to one or more wheels of the trailer.

3. The trailer of claim 2, wherein when the load signal indicates that the trailer is exerting a net force on the towing vehicle, the braking system applies regenerative braking that slows the trailer and charges the power source.

4. The trailer of claim 1, the control system further comprising a control module coupled to the motor, the control module configured to receive the load signal and to generate a propulsion signal based on the load signal.

5. The trailer of claim 4, wherein the motor is configured to receive the propulsion signal and to increase or decrease the propulsive force based on the propulsion signal.

6. The trailer of claim 2, the trailer further configured to detect that the trailer is detached from the towing vehicle, the braking system further configured to apply the braking force based on the determination that the trailer is detached from the towing vehicle.

7. The trailer of claim 1, further comprising one or more wheels, the trailer configured to charge the power source based on rotational energy of the one or more wheels.

8. The trailer of claim 1, wherein the load sensor is a strain gauge or a load cell.

9. The trailer of claim 1, wherein the power source is a battery.

10. The trailer of claim 9, wherein the battery is a lithium-ion battery.

11. The trailer of claim 1, further comprising an independent control interface coupled to the motor, the motor configured to apply the propulsive force based on a user input at the independent control interface.

12. The trailer of claim 11, wherein the independent control interface is detachable from the trailer.

13. The trailer of claim 1, the trailer further comprising a brake light, the trailer configured to activate the brake light based on the load signal.

14. A method of reducing a load on a towing vehicle, the method comprising:
determining a towing force applied by a trailer to the towing vehicle, the towing force including a pushing force when the trailer is pushing the towing vehicle and a loading force when the trailer is loading the motor vehicle;
based on a determination that the trailer is pushing the towing vehicle, reducing a forward force applied to the trailer; and
based on a determination that the trailer is loading the towing vehicle, increasing the forward force applied to the trailer.

15. The method of claim 14, wherein a magnitude of the reduction of the forward force is based on a magnitude of the pushing force and a magnitude of the increase of the forward force is based on a magnitude of the loading force.

16. The method of claim 14, further comprising charging a battery of the trailer with a motor of the trailer based on the determination that the trailer is pushing the towing vehicle.

17. The method of claim 14, further comprising charging a power source of the trailer based on rotational energy of one or more tires of the trailer.

18. The method of claim 14, wherein the step of determining the towing force comprises measuring a load sensor.

19. The method of claim 18, further comprising filtering a load signal from the load sensor.

20. A method of reducing a load on a towing vehicle, the method comprising:
determining that the towing vehicle is traveling in a reverse direction;
determining a towing force applied by a trailer to the towing vehicle, the towing force including a pushing force when the trailer is pushing the towing vehicle and a loading force when the trailer is loading the motor vehicle;
based on a determination that the trailer is pushing the towing vehicle, increasing a rearward force applied to the trailer; and
based on a determination that the trailer is loading the towing vehicle, decreasing the rearward force applied to the trailer.
